(19) United States
(12) Patent Application Publication
(10) Pub. No.: US 2003/0138033 A1
(43) Pub. Date: Jul. 24, 2003

(54) Wireless transmitting device for computer facilities

(76) Inventor: Roger Wu, Hsin Chuang City (TW)

Correspondence Address: Roger Wu, P.O. Box 4-67, Hsin Chuang, Taipei, 242, TW

(21) Appl. No.: 10/055,230

(22) Filed: Jan. 18, 2002

(51) Int. Cl. H04B 1/38; H04L 5/16

(52) U.S. Cl. 375/219

(57) ABSTRACT

A wireless transmitting device includes a computer having a socket disposed in the rear portion, and a wireless LAN device having a USB device for coupling or for plugging to the socket of the computer, without additional electric wires, and for allowing the computer and the wireless LAN device to be easily carried outdoors, and for allowing the computer to be easily coupled to the networks outdoors. The wireless LAN device further includes an antenna for signal receiving and emitting purposes.

### BACKGROUND OF THE INVENTION

1. Field of the Invention

The present invention relates to a wireless transmitting device and more particularly to a wireless transmitting device for computer facilities.

2. Description of the Prior Art

A shown in FIG. 1, typical computer facility, such as the portable computer 11 is coupled to the other computer facilities or coupled to the electric power source with an electric wire 13 and/or a transformer device or a network box 12, for allowing the computer 11 to be coupled to the networks. However, the electric wire 13 may not be easily stored and may not be easily used and coupled to the electric power source, and particularly, may not be easily used outdoors.

The present invention has arisen to mitigate and/or obviate the afore-described disadvantages of the conventional computer facilities.

### SUMMARY OF THE INVENTION

The primary objective of the present invention is to provide a wireless transmitting device for coupling to the computer facilities and for allowing the computer facilities to be connected to the networks and to be used outdoors.

In accordance with one aspect of the invention, there is provided a wireless transmitting device comprising a computer including a socket provided therein, and a wireless LAN device including a USB provided thereon for plugging to the socket of the computer without additional electric wires, and for coupling to the networks outdoors.

The wireless LAN device further includes an antenna for signal receiving and emitting purposes.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view illustrating a typical computer facility having a network box;

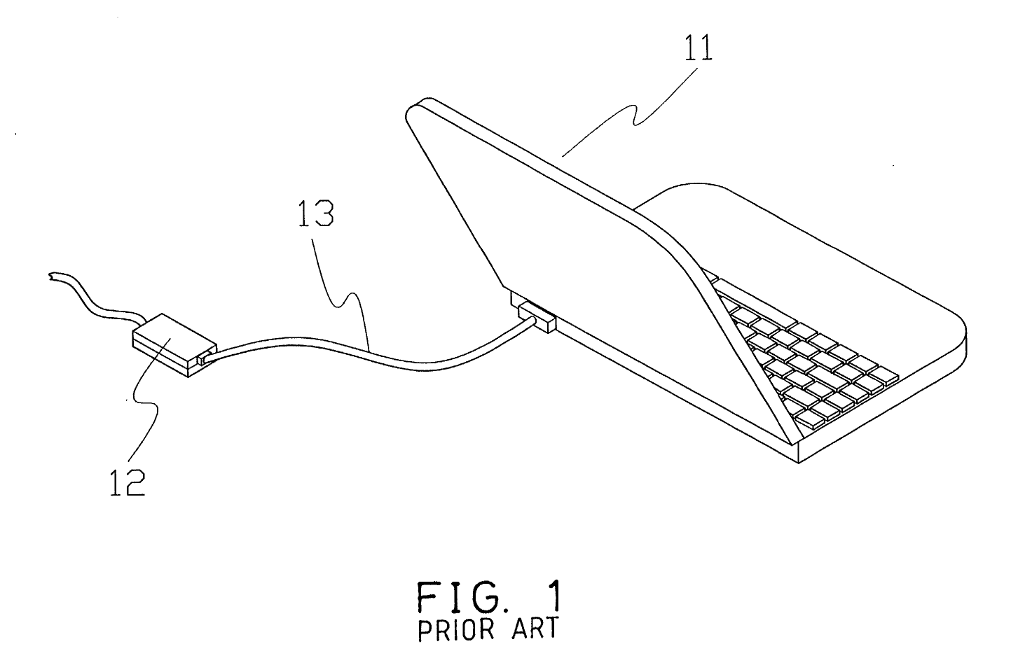

FIG. 2 is a partial exploded view of a wireless transmitting device for computer facilities in accordance with the present invention; and

FIG. 3 is a perspective view of the wireless transmitting device for computer facilities.

### DETAILED DESCRIPTION OF THE PREFERRED EMBODIMENT

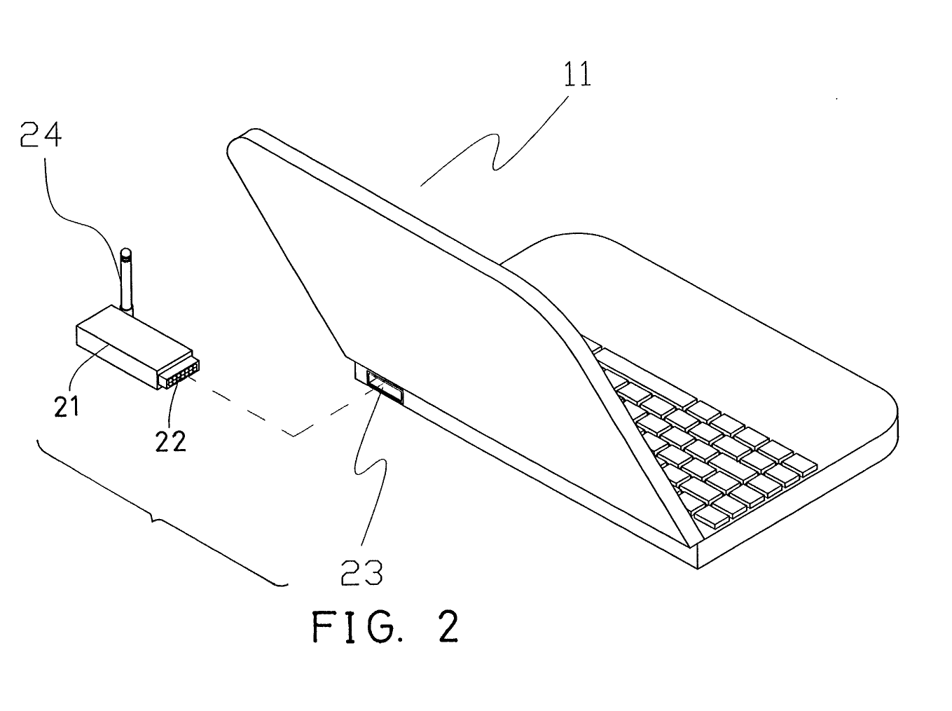

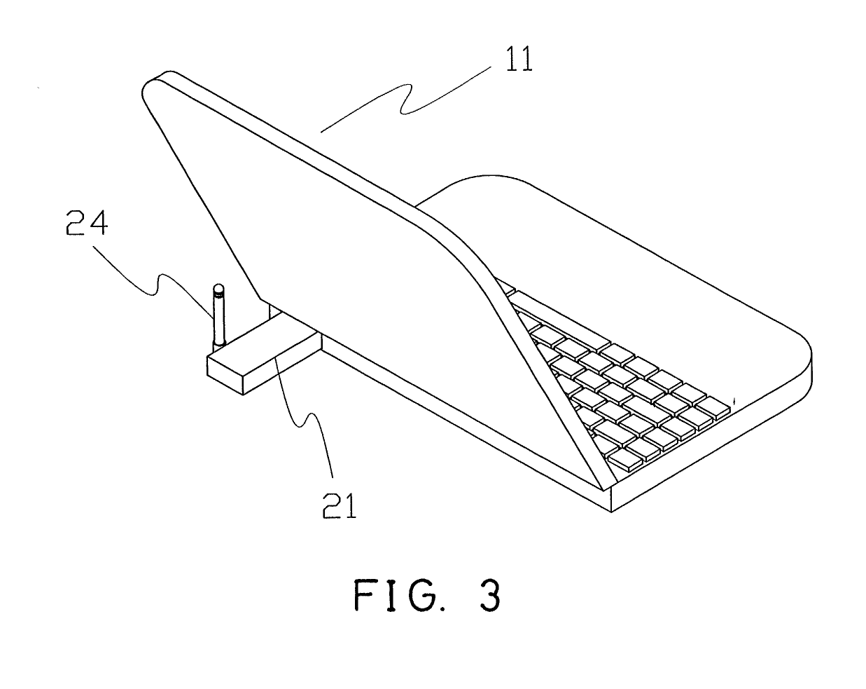

Referring to FIGS. 2 and 3, a wireless transmitting device for computer facilities in accordance with the present invention comprises a computer 11, such as a portable computer 11 including a socket opening or a socket 23 provided therein, such as provided in the rear portion thereof. The wireless transmitting device in accordance with the present invention further comprises a wireless local area network (wireless LAN) device 21, such as the wireless LAN compatible with the IEEE 802.11 standards, and based on the direct sequence spread spectrum (DSSS) technology. The wireless LAN device 21 includes a coupler 221, such as a universal serial bus (USB) 22, provided thereon for coupling or plugging to the socket 23 of the computer 11. The wireless LAN device 21 further includes an antenna 24 for receiving and/or transmitting and/or emitting signals.

It is to be noted that the computer 11 and the wireless LAN device 21 may be easily carried outdoors, and the wireless LAN device 21 may be easily coupled to the computer 11 without additional electric wires, and may thus be coupled to the networks outdoors.

Accordingly, the wireless transmitting device may be used for coupling to the computer facilities and for allowing the computer facilities to be connected to the networks and to be used outdoors.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A wireless transmitting device comprising:
a computer including a socket provided therein, and
a wireless LAN device including a USB provided thereon for plugging to said socket of said computer.

2. The wireless transmitting device according to claim 1, wherein said wireless LAN device further includes an antenna for signal receiving and emitting purposes.
